(19) United States
(12) Patent Application Publication
(10) Pub. No.: US 2025/0381588 A1
(43) Pub. Date: Dec. 18, 2025

(54) Folding Portable Tow Hitch Trash/Hazardous Waste Bin Remediation

(71) Applicant: Brandon Wilson, Yukon, OK (US)

(72) Inventor: Brandon Wilson, Yukon, OK (US)

(21) Appl. No.: 19/224,735

(22) Filed: May 31, 2025

Related U.S. Application Data
(60) Provisional application No. 63/660,135, filed on Jun. 14, 2024.
(60) Provisional application No. 63/668,210, filed on Jul. 6, 2024.
(60) Provisional application No. 63/679,071, filed on Aug. 2, 2024.
(60) Provisional application No. 63/755,971, filed on Feb. 7, 2025.

(51) Int. Cl. B08B 9/093; B60D 1/58

(52) U.S. Cl. CPC B08B 9/093; B60D 1/58; B08B 2209/08

(57) ABSTRACT

A trash/hazardous waste bin cleaner, wherein at least some parts of the waste bin cleaner can be folded up. An attachment for a tow hitch may be included. The bin cleaner preferably includes a wash pan. The wash pan may have one or more curved sides and/or a pyramidal structure to facilitate draining. A drain in the wash pan may also be included, for example attached to a vacuum pump such as a Venturi and/or Venturi-like element. Also, associated methods.

### CROSS REFERENCE TO RELATED APPLICATIONS

This application claims benefit of and priority from the following provisional patent applications:
U.S. provisional application No. 63/660,135 filed Jun. 14, 2024 (kraken-001) for “Folding Portable Tow Hitch Trash/Hazardous Waste Bin Remediation”;
U.S. provisional application No. 63/668,210 filed Jul. 6, 2024 (kraken-002a) for “Folding Portable Trash/Hazardous Waste Bin Remediation”;
U.S. provisional application No. 63/679,071 filed Aug. 2, 2024 (kraken-003a) for “Folding Portable Tow Hitch Trash/Hazardous Waste Bin Remediation”; and
U.S. provisional application No. 63/755,971 filed Feb. 7, 2025 (kraken-004) for “Trash/Hazardous Waste Bin Remediation.”

### STATEMENT REGARDING FEDERALLY SPONSORED RESEARCH OR FUNDING

None.

### NAMES OF PARTIES TO A JOINT RESEARCH AGREEMENT

None.

### INCORPORATED BY REFERENCE STATEMENT

None.

### STATEMENT REGARDING PRIOR DISCLOSURES BY THE INVENTOR OR A JOINT INVENTOR

None.

### REFERENCE TO SEQUENCE LISTING, A TABLE, OR A COMPUTER PROGRAM LISTING COMPACT DISK APPENDIX

None.

### BACKGROUND OF THE INVENTION

The background of this invention is recognition of the problem as discussed below. Recognition of this problem forms part of the inventive effort.

### BRIEF SUMMARY OF THE INVENTION

Aspects and/or embodiments of the disclosed technology may include a portable trash/hazardous waste bin cleaner, wherein at least some parts of the waste bin cleaner can be folded up. An attachment for a tow hitch may be included. Alternatively, the bin cleaner may not include a tow hitch-for example being positioned at a fixed location. The bin cleaner preferably includes a wash pan. The wash pan may have one or more curved sides and/or a pyramidal structure to facilitate draining. A drain in the wash pan may also be included, for example attached to a vacuum pump such as a Venturi and/or Venturi-like element. Also, associated methods are included.

### BRIEF DESCRIPTION OF THE SEVERAL VIEWS OF THE DRAWINGS

The Figures illustrate non-limiting aspects of the subject technology.

FIG. 1 illustrates a possible design for a folding portable trash/hazardous waste bin cleaner according to aspects of the subject technology.

FIG. 2 illustrates some further details of a possible design for a folding portable trash/hazardous waste bin cleaner according to aspects of the subject technology.

FIG. 3 illustrates a possible use of a folding portable trash/hazardous waste bin cleaner according to aspects of the subject technology.

FIG. 4 illustrates a possible tow hitch attachment for a folding portable trash/hazardous waste bin cleaner according to aspects of the subject technology.

FIG. 5 illustrates a possible embodiment of a portion of a folding portable trash/hazardous waste bin cleaner according to aspects of the subject technology.

FIG. 6 illustrates another possible embodiment of a portion of a folding portable trash/hazardous waste bin cleaner according to aspects of the subject technology.

FIG. 7 illustrates yet another possible embodiment of a portion of a folding portable trash/hazardous waste bin cleaner according to aspects of the subject technology.

### INCORPORATION BY REFERENCE

The following provisional patent applications are hereby incorporated by reference as if fully set forth herein:
U.S. provisional application No. 63/660, 135 filed Jun. 14, 2024 (kraken-001) for “Folding Portable Tow Hitch Trash/Hazardous Waste Bin Remediation”;
U.S. provisional application No. 63/668,210 filed Jul. 6, 2024 (kraken-002a) for “Folding Portable Trash/Hazardous Waste Bin Remediation”;
U.S. provisional application No. 63/679,071 filed Aug. 2, 2024 (kraken-003a) for “Folding Portable Tow Hitch Trash/Hazardous Waste Bin Remediation”; and
U.S. provisional application No. 63/755,971 filed Feb. 7, 2025 (kraken-004) for “Trash/Hazardous Waste Bin Remediation.”

### DETAILED DESCRIPTION OF THE INVENTION

### I. The Problem

Dealing with trash and trash/hazardous waste bins is annoying, dirty, and rife with the potential for disease transmission. Current approaches before this invention come with significant safety and health risks.

### II. The Solution

One possible solution to the above-described problem and possibly other problems may be a portable trash/hazardous waste bin cleaner, wherein at least some parts of the waste bin cleaner can be folded up to facilitate transportation. An attachment for a tow hitch may be included. The bin cleaner preferably includes a wash pan. The pan may fold up for driving around and maybe can be lowered down flat at a stop to wash trash/hazardous waste bins. The wash pan may have one or more curved sides to facilitate draining. A drain in the wash pan may also be included, for example to attach to a vacuum pump. Further, a dispenser for deodorizer(s) may be included. The subject technology also includes associated methods of manufacture, use, and the like.

The waste bins which may be cleaned preferably can be of any size ranging from normal household trash cans, typical garbage bins (i.e., of the type people often put outside for pickup), and/or large residential and/or commercial dumpsters.

Embodiments/aspects of the subject technology preferably may be applicable to some and/or all such waste bins.

Aspects of the subject technology may include a hitch connection with a portable folding base for space saving and more affordable option for a trash can cleaning system. The folding base may have one or more spray heads attached to it with a collection pan underneath to collect debris and/or polluted water.

The hose from the clean water preferably goes to the spray head(s) while the dirty water hose collects from the collection pan and preferably moves the water through the recycling filter system.

The recycling system may sit in the bed of a truck or utility van while the spray head(s) preferably remain portable and detachable from the water tank(s).

The clean water tank(s) preferably have a second hose which may be connected to a 10 gallon per minute pressure washing system with 185° water for sanitation purposes.

In some aspects, elements for introducing detergent, do-odorizers, and/or the like may be included.

Being portable and compact, this subject technology is likely to be far more affordable for start-up businesses. The hose that connects to the spray head preferably can also hook directly to a water faucet and still be used to clean trash/hazardous waste bins effectively.

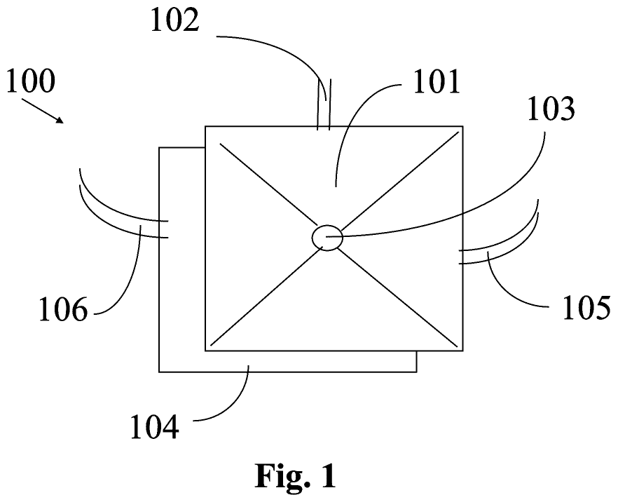

FIG. 1 illustrates a possible design for a folding portable trash/hazardous waste bin cleaner 100 according to aspects of the subject technology. Element 101 represents a top part connected to or otherwise engaging a folding base. Element 102 represents a hitch to a vehicle. Element 103 represents a spray head, for example to clean out a vehicle from dirt, garbage, and/or potentially hazardous materials. Element 104 represents a pan for hopefully safely collecting dirt, garbage, and/or potentially hazardous materials.

Element 105 represents an outflow of potentially contaminated water and/or cleaning chemicals. While pan 104 is intended to collect such, no de-contamination process is perfect.

Clean water hose/source 106 is preferably provided to provide clean water for decontamination and sanitary purposes.

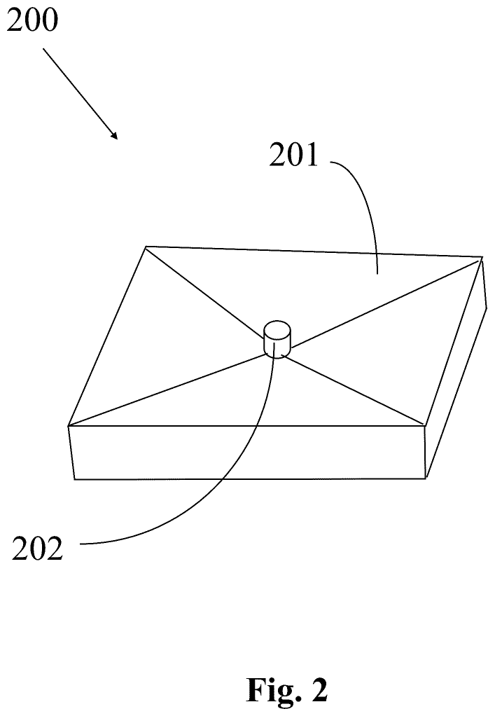

FIG. 2 illustrates some further details of a possible design 200 for a folding portable trash/hazardous waste bin cleaner according to aspects of the subject technology. Element 201 represents a potentially folding base. Element 202 represents a filtering device of some form, possibly using charcoal or other cleansing agents.

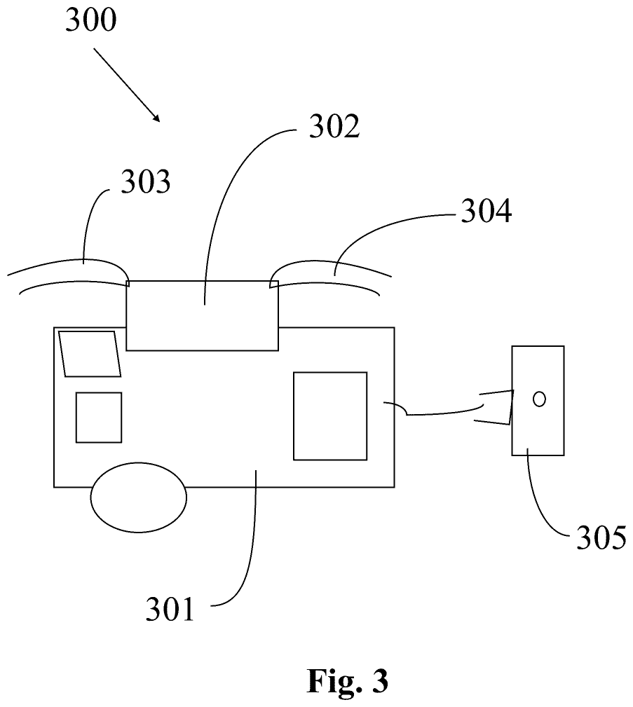

FIG. 3 illustrates a possible use 300 of a folding portable trash/hazardous waste bin cleaner according to aspects of the subject technology. Vehicle 301 may be carrying hazardous material(s). Inflow 303 and outflow 304 may expose people to such materials. Element 305 represents a system and/or method according to the subject technology to at least attempt preventing such.

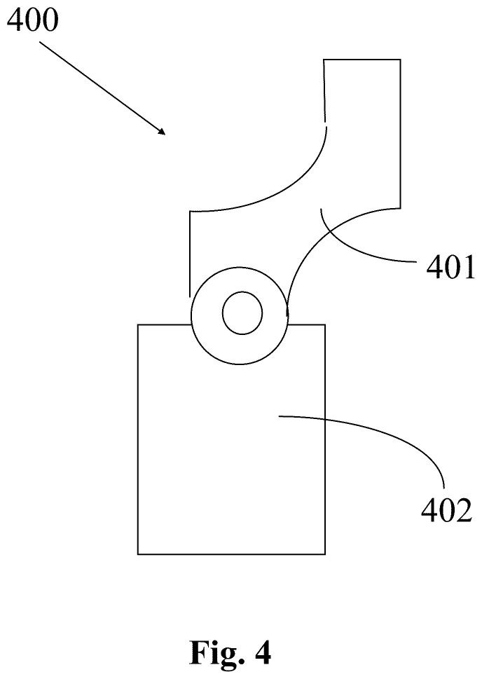

FIG. 4 illustrates a possible tow hitch attachment 400 for a folding portable tow hitch trash/hazardous waste bin cleaner according to aspects of the subject technology. Hitch 401 may be attached to or a part of any vehicle such as a garbage truck, waste disposal vehicle, van, pickup truck, and/or any other vehicle. Element 402 represents aspects of the subject technology as discussed herein. While an attachment for a tow hitch preferably is included, such is not necessarily part of some embodiments of the subject technology.

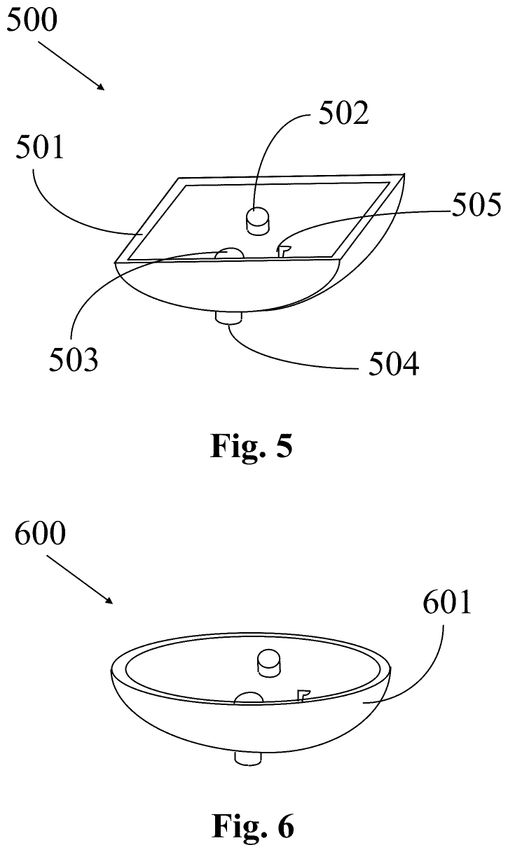

FIG. 5 illustrates possible embodiment 500 of a portion of a folding portable trash/hazardous waste bin cleaner according to aspects of the subject technology. The embodiment includes a wash pan 501. The pan may include one or more walls as shown. Some or all the walls may be curved for example to facilitate drainage. Double walls or other structures may be used.

Spray head 502 preferably is included for cleaning a waste bin placed upside down in pan 501. The spray head preferably rotates by force of water and/or cleaning solutions moving through it.

Drain 503 preferably permits outflow of dirty water, cleaning solution, and the like, The drain may also be configured to create or to adapt/connect to a vacuum, vacuum-like, and/or low pressure condition. In some embodiments, a Venturi and/or Venturi-type system may be used to create the low pressure condition.

Drain, drain plug, and/or attachment 504 preferably is connected to drain 503. A vacuum system and/or pump may draw fluid through drain 503 via drain, drain plug, and/or attachment 504.

Element 505 represents an optional dispenser 505 for deodorizer(s). Deodorants and/or other cleaning solutions may be injected into pan 501 before, during, and/or after cleaning of a waste bin.

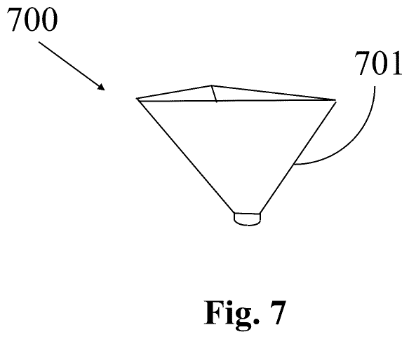

FIG. 6 illustrates another possible embodiment of portion 600, for example wash pan 501, of a folding portable trash/hazardous waste bin cleaner according to aspects of the subject technology. Walls 601 (possibly double sided) are shaped in the form of a complete bowl. FIG. 6 does not illustrate all internal elements that may be present. Reference to FIG. 5 and other parts of this disclosure are incorporated.

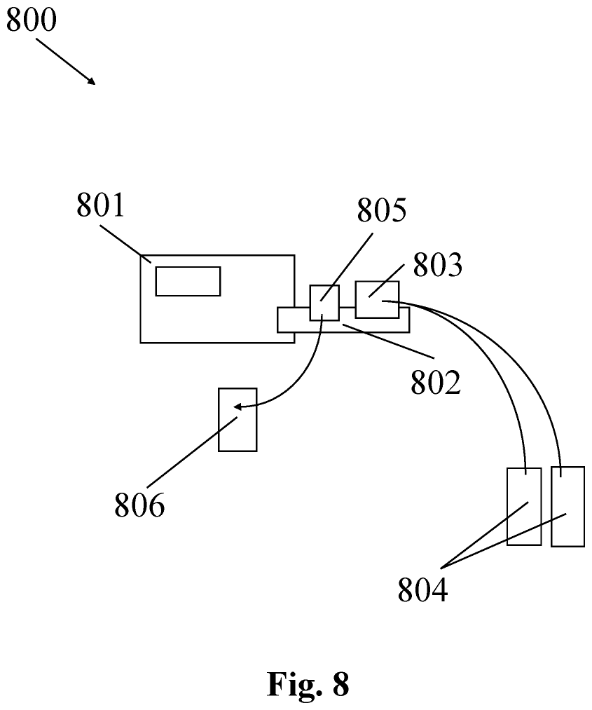

FIG. 7 illustrates yet another possible embodiment of portion 700, for example wash pan 501, of a folding portable trash/hazardous waste bin cleaner according to aspects of the subject technology. Walls 701 (possibly double sided) have a pyramidal structure. While the pyramidal structure is illustrated as having three sides, any number of sides may be used. FIG. 7 does not illustrate all internal elements that may be present. Reference to FIG. 5 and other parts of this disclosure are incorporated.

FIG. 8 illustrates a permanent and/or semi-permanent attachment of a trash/hazardous waste bin cleaner according to aspects of the subject technology. This figure shows that some and/or all of the above described elements may be permanently and/or semi-permanently attached to a trailer or vehicle. This embodiment may or may not include a folding aspect as discussed above.

In more detail, cleaning system 800 includes multiple elements of a garbage bin cleaning system. Other elements may be added and some illustrated elements may be omitted.

Element 801 represents a vehicle such as a truck or car. The vehicle preferably includes a trailer and/or other cargo space 802. This cargo space may be integral to vehicle 801 and/or attached thereto such as via a trailer hitch.

Element 803 represents a bin cleaning system as described above, for example one including a Venturi pump system. The bin system preferably is permanently and/or semi-permanently attached to vehicle 801 and/or cargo space 802 (i.e., a trailer). Of course, no construct in reality is truly permanent, but in preferred embodiments the intent is to make such as permanent as feasible. Non-permanent embodiments (i.e., just putting a system on a trailer) are also contemplated.

Garbage bins 804 are illustrated as being cleaned by the bin cleaning system.

Elements 805 and 806 represent dirty water aka “grey water” disposal receptacles for holding water after being used to clean garbage bins 804. These receptacles are preferably provided so dirty and possibly toxic water can be disposed of properly. As shown, such receptacles may be integrated into the system 800 or may be outside the system.

Any other structures besides those shown in the Figs. and/or discussed above for a wash pan, cleaning system, and/or other parts of a waste bin cleaner/system may be used. For example, additional element including but not limited to a blower to dry a waste bin, elements to assist with positioning a waste bin on the bin cleaner, and the like may also be incorporated.

All or some of the trash/hazardous waste bin cleaner according to aspects of the subject technology may be made of any suitable material(s). Examples include but are not limited to steel, aluminum, and plastic. Use of aluminum for many parts is preferred due to its strength, relatively light weight, and resistance to corrosion.

### III. Generality

The invention is in no way limited to the specifics of any particular aspects disclosed herein. For example, the terms “aspect(s),” “embodiment(s),” “element(s),” “represents,” “illustrates,” “example(s),” “e.g.,” “possible,” “possibly,” “preferably,” “preferred,” “can,” “may,” “likely, “generally,” “of note,” “note,” and the like denote features that may be preferable but not necessarily essential to include in some embodiments of the invention. Also, the subject technology may be used with bins other than waste bins.

Additional element(s) may be added to various aspects of the invention and/or some disclosed element(s) may be subtracted from various aspects of the invention without departing from the scope of the invention. Singular element(s) imply plural element(s) and vice versa.

Details illustrated or disclosed with respect to any one aspect of the invention may be used with other aspects of the invention. The term “and” generally includes “or” and vice versa. Many other variations/embodiments are possible which remain within the content, scope, and spirit of the invention, and these variations/embodiments would become clear to those skilled in the art after perusal of this application.

What is claims is:

1. A trash/hazardous waste bin cleaner, wherein at least some parts of the waste bin cleaner can be folded up.

2. The waste bin cleaner of claim 1, further comprising an attachment for a tow hitch.

3. The waste bin cleaner of claim 1, wherein the bin cleaner further comprises a wash pan.

4. The waste bin cleaner of claim 3, wherein the wash pan has one or more curved sides.

5. The wash bin cleaner of claim 3, wherein the wash pan has a pyramidal structure.

6. The waste bin cleaner of claim 3, further comprising a drain in the wash pan.

7. A trash/hazardous waste bin cleaner, comprising:
at least one spray head; and
at least one wash pan with at least one drain;
wherein the drain is attached to a Venturi or Venturi-like element.

8. The waste bin cleaner of claim 7, further comprising the Venturi or Venturi-like element.

9. The waste bin cleaner of claim 6, wherein the drain is attached to a vacuum pump incorporating or otherwise associated with the Venturi or Venturi-like element.

10. The waste bin cleaner of claim 9, further comprising the vacuum pump.

11. The waste bin cleaner as in claim 7, wherein the bin cleaner is positioned at a fixed location.

12. A trash/hazardous waste bin cleaning method, comprising:
using at least one spray head; and
using at least one wash pan with at least one drain;
wherein the drain is attached to a Venturi or Venturi-like element.

13. The waste bin cleaning method of claim 12, wherein the drain is attached to a vacuum pump incorporating or otherwise associated with the Venturi or Venturi-like element.

14. The waste bin cleaning method of claim 13, further comprising using the vacuum pump.

15. The waste bin cleaning method as in claim 12, wherein the method occurs at a fixed location.
